(19) United States
(12) Patent Application Publication
(10) Pub. No.: US 2004/0052615 A1
(43) Pub. Date: Mar. 18, 2004

(54) Wire comb binding element method and device

(76) Inventors: Ferdinand Fuchs, Nurtingen (DE); Hartmut Reusch, Metzingen (DE); Fritz Witte, Wendlingen (DE); Hans-Peter Wurschum, Ostifildern (DE)

Correspondence Address: Kevin L. Leffel, Heidelberg Digital L.L.C., 2600 Manitou Road, Rochester, NY, 14624, US

(21) Appl. No.: 10/443,521

(22) Filed: May 22, 2003

(30) Foreign Application Priority Data
May 27, 2002 (DE) 102 23 481.7

(51) Int. Cl. B42B 5/10

(52) U.S. Cl. 412/39

(57) ABSTRACT

The invention relates to a methods and devices for bending wire binding elements that are used in a wire comb binding. According to various aspects of the invention, methods and devices are provided for bending wire binding elements that are adapted in particular to varying thicknesses of stacks of sheet-form printing materials, preferably without retooling.

The invention relates to a methods and devices for bending wire binding elements that are used in a wire comb binding.

Methods for production of booklets, which use so-called Wire-O® wire binding elements in various sizes, are known, for example, from the European Patent application s 0 095 243 A1 and 0 095 245-B1.

Wire-O® binding elements are defined as wire loops that are spaced parallel to each other and have a loop length L, a loop spacing A and a wire diameter D, as depicted in FIG. 2a, and are shaped into a ring using appropriate closure devices.

The binding devices for the patent applications indicated above are thus configured so that it is possible to process pre-formed Wire-O® wire binding elements with different loop intervals and lengths. The pre-formed Wire-O® wire binding elements thus consist of wire loops that form a C-shaped or ω-shaped structure. The C-shaped or ω-shaped structure is closed after the sheet-form printing materials have been threaded into the wire binding element through their holes in such a manner that a circular ring binding is produced. The ω-shaped structure is produced if a bead was incorporated in the center of the loop of the wire binding element. A bead of this type can ease the closing operation of the pre-formed Wire-O® wire binding element.

Generally, there exists the disadvantage in the aforementioned devices that, for the binding of booklets of varying format and thickness, the needed wire binding elements must be made available to the binding device in the form of several already formed binding element stocks, e.g. as reel-fed material or as elements cut to binding length. In order to be able to bind these varying booklet formats and thicknesses, a considerable number of stocks is necessary.

Moreover, for a size change of the booklets to be produced, the devices, which are suited for transport and for processing, must be adapted to the requirements of the different wire binding elements. This retooling requires complicated designs of the transport and binding devices and makes it so the binding process only remains economical if greater piece counts of a particular booklet thickness are produced in one format. Smaller runs are therefore uneconomical to produce and, due to the machine adaptation, require a greater amount of time.

From German Patent 28 47 700 A1, a method is known for producing a wire binding for books in sheets, etc. in which a wire that is continuously drawn from a stock is shaped into a wavy structure by bending back and forth, the wavy structure wire structure then being bent into a C-shaped form, transverse to the plane of the waves. Forming rollers having specified diameters are used for bending, so that it is only possible to produce wire binding elements having unalterable loop spacing and lengths.

Using a device for producing booklets of varying format and thickness via wire comb binding, with which the wire binding elements can be produced directly in the binding process corresponding to its requirement and the particular format and thickness of the booklets to be bound, each wire loop of the wire comb must be bent together into a ring. In so doing, one must take into account that the radius of the resulting ring is a function of the stack thickness of the sheet-form printing materials and, thus, of the particular wire loop length.

### SUMMARY OF THE INVENTION

According to various aspects of the invention, methods and devices are provided for bending wire binding elements that are adapted in particular to varying thicknesses of stacks of sheet-form printing materials, preferably without retooling.

### BRIEF DESCRIPTION OF THE DRAWINGS

FIG. 1 presents a schematic diagram of the structure of an embodiment of a device according to one aspect of the invention.

FIG. 2a presents an illustration of a flat, looped wire binding element.

FIG. 2b presents an illustration of a looped wire binding element in a C-shape.

FIG. 3 presents an embodiment of a booklet bound via a looped wire binding element that is bent overall in an O-shape.

FIG. 4a presents an embodiment of a booklet bound using a plurality of individual wire binding elements.

FIG. 4b presents an embodiment of a bound booklet using a plurality of individual wire binding elements that are spaced apart from each other.

FIG. 5 presents a diagrammatic illustration of the C-formers during centering of the points of the wire binding element.

FIG. 6 presents a diagrammatic illustration of the C-formers during centering of the base side of the wire binding element.

FIG. 7 presents a diagrammatic illustration of the C-formers with a wire binding element inserted in the tabs.

FIG. 8 presents schematic diagram of the insertion or clamping position of the C-formers.

FIG. 9 presents a diagrammatic illustration of the O-formers.

FIG. 10 presents a diagrammatic illustration of the pivot points of the C-formers and O-formers inside the looped wire binding elements.

FIG. 11 presents a diagrammatic illustration of the procedural sequence of the present invention.

### DETAILED DESCRIPTION

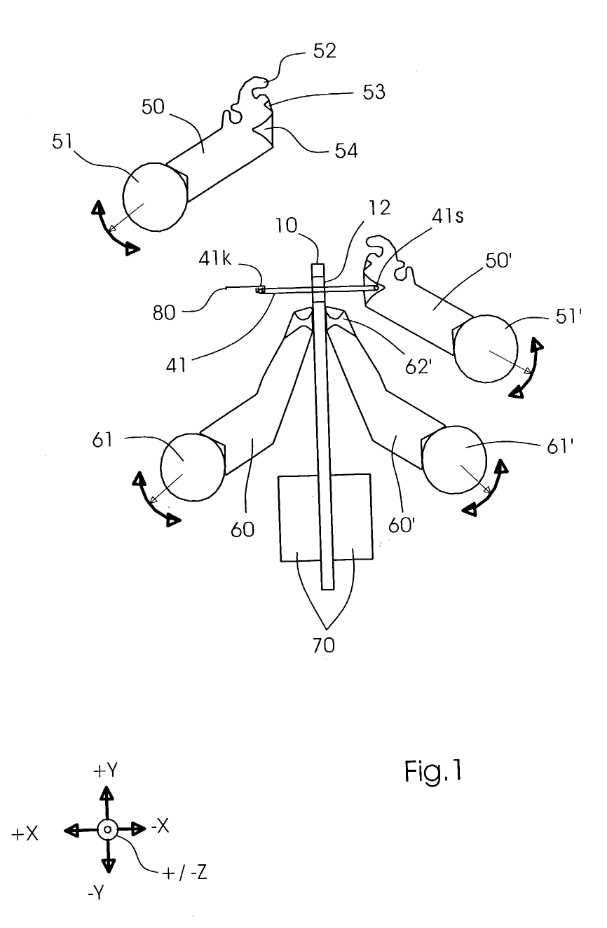

Various aspects of the invention are presented with reference to FIGS. 1-11, which are not drawn to any particular scale, and wherein like components in the numerous views are numbered alike. Referring now specifically to FIG. 1, the overall structure of an device of the present invention, of which, for the sake of simplified description, only the components that are essential to the invention are depicted or explained. Additional drive and/or guiding means as well as electrical/electronic circuits, which are generally known and required for the operation of the device, are not illustrated or are described only in general form.

The device according to one aspect of the present invention is essentially comprised of a pair of C-formers 50, 50′, which together bend a flat, looped wire binding element 41 into a preliminary C-shape 41c and a pair of O-formers that bend the looped wire binding element 41 that is bent into C-shape 41c into a closed O-shape 41o for the loose binding of sheet-form printing materials 11 into booklets 10.

A stack of sheet-form printing materials 11, which have a plurality of holes 12 and when laid one on top of the other with the outer edges in alignment form an essentially straight passage for loops S of flat wire binding element 41, is clamped into a pincer 70. The sheet-form printing materials could, for example, be delivered by pincers 70, especially if the device of the present invention belongs to a higher order system. In another embodiment, pincers 70 are a fixed component of the device of the present invention, especially if the embodiment is a tabletop device for loose binding of booklets 10.

C-formers 50, 50′ are each mounted on a shaft 51, 51′ and are driven, guided and controlled in such a manner that they can execute a rotary movement around the particular shaft 51, 51′, as is indicated by the corresponding arrows in FIG. 1. Also provided are stepper motors, guides and control means (not shown), which are known to the person of ordinary skill in the field, for both C-formers 50, 50′, so that C-formers 50, 50′ also travel in the X-direction and Y-direction in a controllable manner. The use of stepper motors permits an especially great flexibility in the drive and configuration of the movement of C-formers 50, 50′; the same is true for O-formers 60, 60′.

O-formers 60, 60′ also have corresponding drives, guiding devices and control means (not shown) that are known to the person of ordinary skill in the field for rotary movements around the particular shaft 61, 61′ and along the X-direction or Y-direction. Furthermore, drives, guiding means and control means for the O-formers 60, 60′ are provided that can be used to move O-formers 60, 60′ in the Z-direction. The Cartesian coordinates that are used in this context are indicated in the coordinate axes in FIG. 1.

C-formers 50, 50′ have a geometric shape that permits a centering and a gripping of the looped wire binding elements 41. For this purpose, tabs 52 are provided for gripping, or clamping looped wire binding element 41 as well as centering elements 53, 53′ and centering funnels 54, 54′.

O-formers 60, 60′ also have tabs 62, 62′ that are used for clamping and bending looped wire binding element 41 into C-shape 41c and are described in greater detail below.

C-formers 50, 50′ positioned one below the other and respective O-formers 60, 60′, one below the other, are not substantially different in structure except for the mirror symmetry; however, in addition, especially for the description of the method of the present invention, one speaks of a first C-former 50 and a second C-former 50′ as well as a first O-former 60 and a second O-former 60′. In this context, first C-former 50 or first O-former 60 are each characterized in that they are arranged on the side of the sheet-form printing materials 11, at which base side 41k of looped wire binding element 41 is situated. As a result it turns out that second C-former 50′ or second O-former 60′ are each characterized in that they are arranged on the side of the sheet-form printing materials 11, at which points 41s of loops S of looped wire binding element 41 are situated.

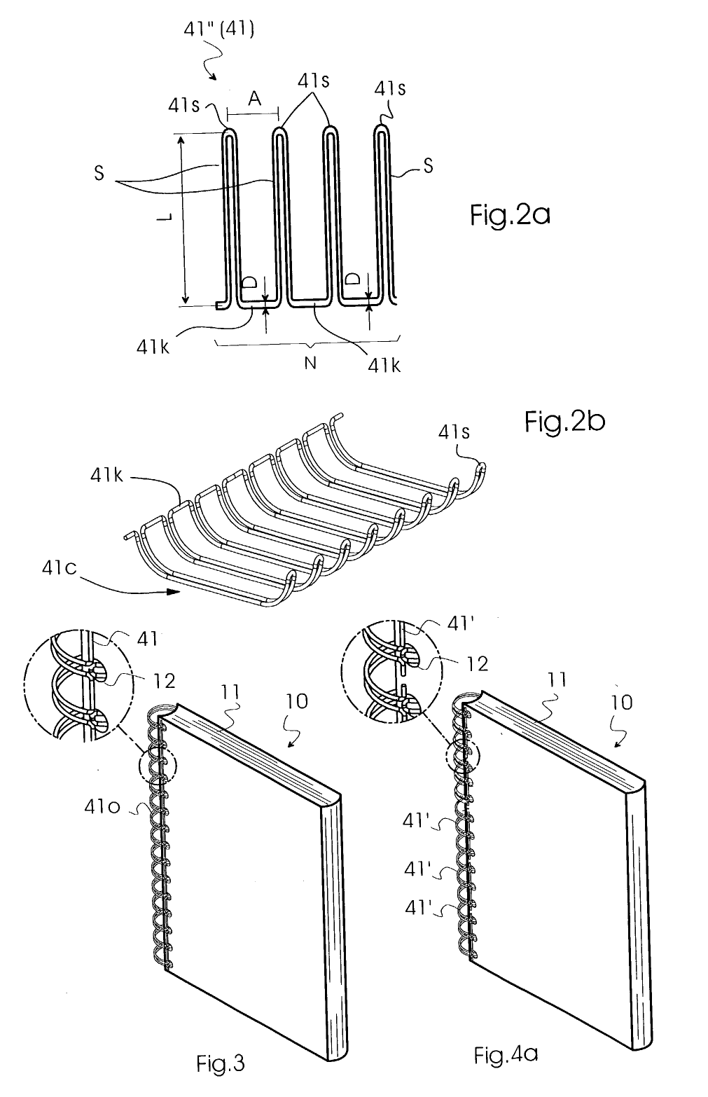

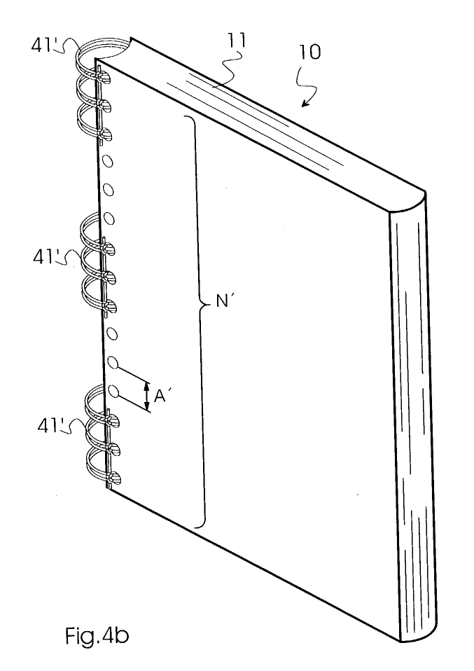

In FIG. 2a a looped wire binding element 41 is illustrated with four loops S. Loops S have a spacing A from peak 41s to peak 41s, and a wire diameter D, a loop length L and a quantity N of loops S. Moreover, the base sides are marked with reference number 41k and the loop points of wire binding element 41 are marked with reference number 41s. Spacing A thus corresponds to spacing A′ of holes 12 in sheet-form printing materials 11 (see FIG. 4b). However, the number of holes N′ in sheet-form printing material does not necessarily correspond, as explained below, to the number N of loops S, but rather represents a maximum for the reasonable number N of loops S of wire binding element 41.

The loop length L specifies the diameter of wire binding element 41 in closed O-shape 41o and can be made a function of the number of sheet-form printing materials 11. The diameter of a wire binding element 41 that is bent into a O-shape 41o is selected so that the bound booklet 10 gets an aesthetic exterior, it is easy to turn its pages and is easy to stack. In FIG. 2b, a looped wire binding element 41 in C-shape 41c is shown. The looped wire binding element 41 in C-shape 41c represents an intermediate product, and it also can be purchased in a similar form for the production of Wire-O® bindings. However, in the device of the present invention and in the method of the present invention, in contrast to the prior art, a booklet that is to be bound is already located inside the loops if the wire binding element 41 obtains the C-shape 41c.

Shown in FIG. 3 is a finished bound booklet 10 with a wire binding element 41 that is bent completely into an O-shape 41ₒ and has a continuous binding. FIG. 4a shows a single binding that is comprised of wire binding elements 41′, which each have only a single loop, and for each hole 12 in the printing stock precisely one wire binding element 41′ is used. Illustrated in FIG. 4b is a wire comb binding that consists of several wire binding elements 41′, for example multi-loop ones, which are spaced from each other in such a manner that holes 12 remain open. Any other combination from the aforementioned possibilities is clear to the person of ordinary skill in the field.

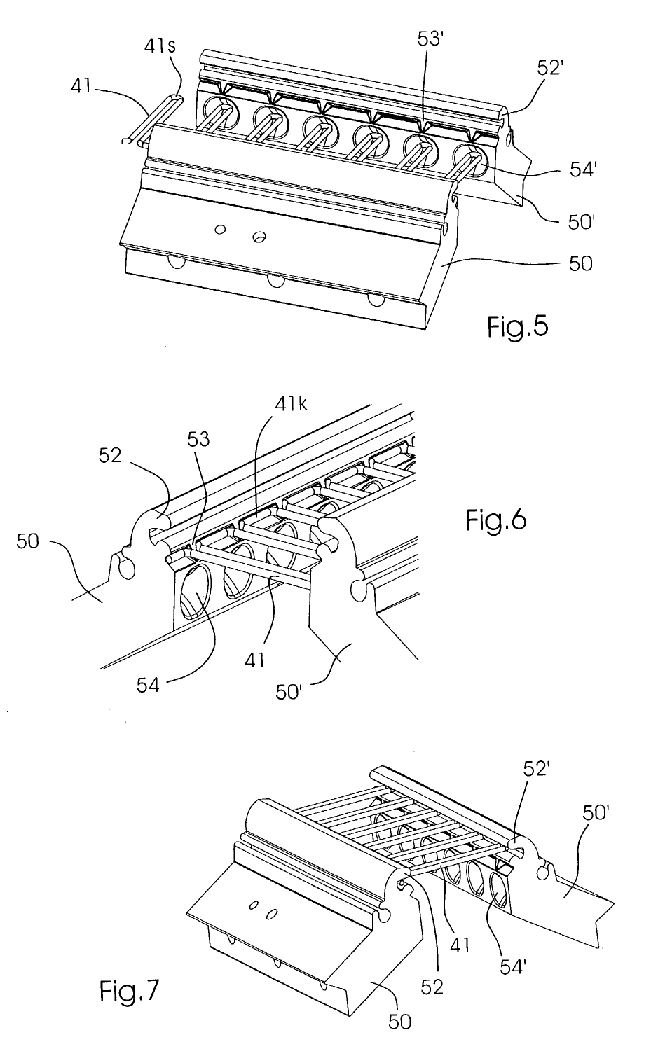

Shown in FIG. 5 are details of the centering of a flat, looped wire binding element. This shows, on the one hand, centering funnels 54, 54′ into which the points 41s of the flat, looped wire binding element are inserted. On the other hand, it shows wedge-shaped centering elements 53 (see also FIG. 6) that push against the base side 41k of wire binding element 41 between the ends of loops S and thereby set the position of loops S on base side 41k. In this context, the width of the section of centering element 53, which is pushed between the legs of loop S, is essentially such that the legs of loop S are parallel to each other. In this way, the parallelism of loops S to each other is supported.

As is recognizable in FIGS. 5 to 7, tabs 52, 52′, which are used to grasp and clamp the looped wire binding element 41, are continuous profiles for all loops S of wire binding element 41, which on their part have no additional components. The position of the wire binding element within these tabs 52, 52′, as illustrated in FIG. 7, is secured solely by clamping, the clamping being achieved by a rotation of C-formers 50, 50′. Due to this structure with a continuous profile of tabs 52, 52′, an especially great stability of C-formers 50, 50′ can be achieved in this area. Moreover, the manufacturing effort is comparatively little.

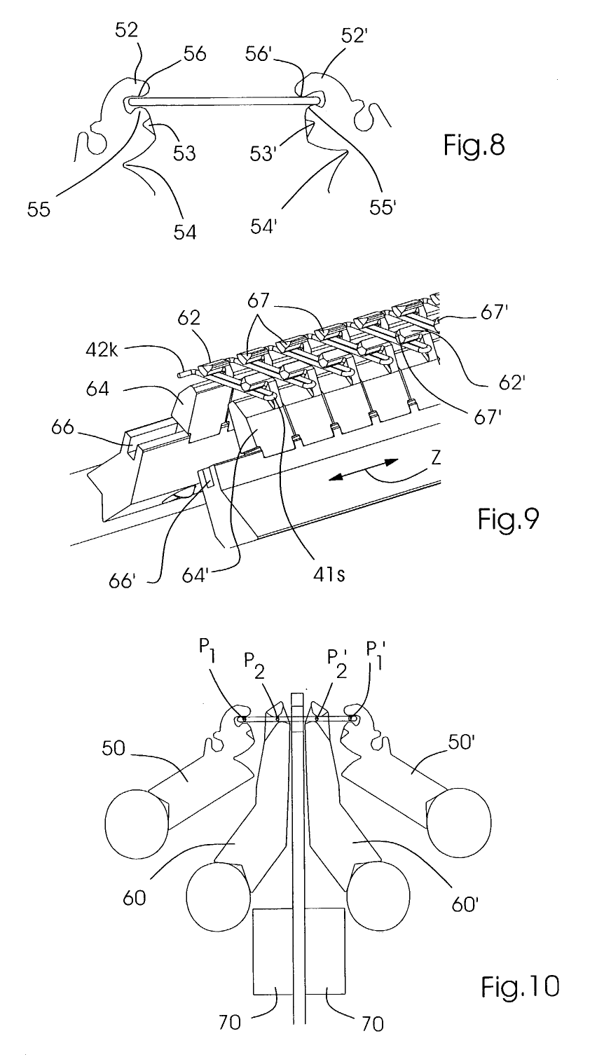

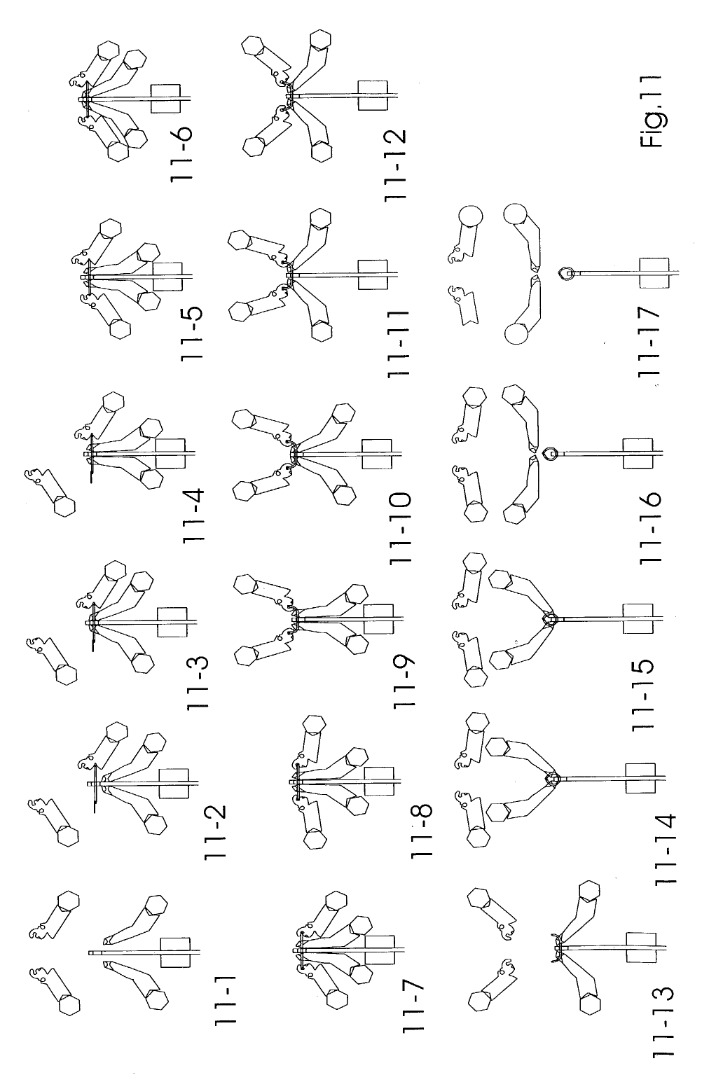

The principle of clamping the wire binding element 41 is shown in detail in FIG. 8. Shown in FIG. 8 is first C-former 50 in an insertion position. Lower tab flank 56 and opposing clamp flank 55 are not yet in contact with wire binding element 41. First C-former 50 is in this insertion position when approaching a flat wire binding element that is held by O-former 60, 60′ or a comb-threading device (not shown). Second C-former 50′ is shown in FIG. 8 already in a clamping position. To do this, second C-former 50′ is swung counterclockwise around a pivot point P1′ (see FIG. 10) with respect to the insertion position, until bottom tab flank 66′ and clamp flank 65′ of second C-former 50′ first contact flat wire binding element 41 and when swung further, in this case in the counterclockwise direction, a great enough pressure is developed between flanks 65′, 66′ and the wire binding element that wire binding element 41 can no longer slip.

In FIG. 9, the structure of O-formers 60, 60′ is shown diagrammatically. O-formers 60, 60′ have a number of individual bending elements 64, 64′ that can each be attached to individual O-formers 60, 60′ along a groove 66, 66′. Each bending element 64, 64′ has a hooked tab 62, 62′ with a flat underside that is joined on one side to the bending element body of bending element 64, 64′. In this context hooked tabs 62, 62′ of the bending elements are symmetrically mounted on first O-former 60 so that all tabs of both O-formers 60, 60′ point in the same direction.

The length of tabs 62, 62′ is adapted to the loop shape of wire binding element 41. On the one hand, tabs 62, 62′ on the inner side are longer than the width of loops S, so that each loop S can be securely grasped with a tab 62, 62′. On the other hand, tabs 62, 62′ are shorter in overall length than the distance between two loops S.

As described above, O-formers 60, 60′ are equipped with an additional drive in the Z-direction. Due to a combination of a movement in the Y-direction and Z-direction of O-formers 60, 60′, tabs 62, 62′ first dip between loops S of a wire binding element 41 that is inserted in the device of the present invention and then move in the Z-direction above the loops in order then to clamp and bend them by rotating O-formers 60, 60′ in a manner similar to the movement of C-formers 50, 50′ that is described above.

The clamping and bending mechanism runs in the X-Y plane as described above. The clamping of a wire binding element 41 by rotating C-formers 50, 50′ or O-formers 60, 60′ can thus be achieved by rotation both toward sheet-form printing materials 11 and away from sheet-form printing materials 11.

In FIG. 10, the position of pivot points P1, P1′, P2, P2′ inside the wire binding element is shown in diagrammatic illustration. It should be pointed out that, although the pivot points are shown in FIG. 10 in reference to a flat wire binding element 41, the inner pivot points P2, P2′ are actually inside the wire binding element even if the wire binding element is not flat, for example, if it is C-shaped.

The tabs 62, 62′ of O-formers 60, 60′ have chamfers 67, 67′ on their sides facing away from loops S in the clamping position. These chamfers 67, 67′ facilitate the dipping of bending elements 64, 64′ between the loops.

The movement sequence of the device of the present invention during execution of the method of the present invention is explained in detail below in reference to FIGS. 11-1 to 11-17. The movement sequences in this method are controlled by a controller (not shown) that is known from the prior art for the various stepper motors (also not shown) that are known to the person of ordinary skill in the field and are responsible for the movement of C-formers 50, 50′ or 60, 60′. In this context, the speed profiles that are required for this may, for example, be calculated or read from tables; the speed profiles of the movements of the individual drives are in particular a function of loop length L of looped wire binding element 41.

In FIG. 11-1 the device of the present invention is in a base position. A stack of sheet-form printing materials with aligned holes 12 are clamped in pincers 70 so that holes 12 of sheet-form printing material 11 are located in a comb-threading plane for wire binding element 41. C-formers 50, 50′ are located above the comb-threading plane, O-formers 60, 60′ are located beneath the comb-threading plane and, depending the thickness of the booklets 10 to be bound, are spaced in such a manner that in the assumed position they act as fan-out inhibitors for sheet-form printing materials 11, especially if pincers 70 swing sheet-form printing materials 11 from below into the planned position. In this way individual sheet-form printing materials 11 that have spread apart are aligned.

If sheet-form printing materials 11 are in the planned position, second C-former 50′ moves downward into the centering position of the flat, looped wire binding element 41 as illustrated in FIG. 11-2. Second C-former is in the centering position if centering funnels 65′ of second C-former 50′ are aligned with holes 12 of sheet-form printing materials 11. O-formers 60, 60′ run together beneath the comb-threading plane in the X-direction until sheet-form printing materials 11 are aligned. Next, a flat wire binding element 41 is threaded/combed into sheet-form printing materials 11 through holes 12. Looped wire binding element 41 is pushed in up to the stop with points 41s in centering funnels 65′ of second C-former 50′. Advantageously, wire binding element 41 is held in this position with a comb-threading device, but a manual introduction of wire binding element 41 is also possible.

On the other hand, this can also involve a plurality of wire binding elements 41, 41′, 41″, as is described above and shown in FIGS. 4a and 4b. For the sake of simplicity, a single wire binding element 41 is assumed, although a plurality of wire binding elements 41,41′, 41″ does not represent a difference for the method of the present invention.

In the next step, which is illustrated in FIG. 11-3, O-formers 60, 60′ move up in the Y-direction and dip in between loops S of wire binding element 41.

Next, O-formers 60, 60′ approach the correct mesh point for C-shape 41c to be produced. This C-shape 41c that is to be produced is in particular a function of loop length S and, consequently, the diameter of the finished O-shape and, thus, the thickness of booklet 10 that is to be bound. Then, O-formers 60, 60′ move in the Z-direction with their tabs 62, 62′ above loops S until tabs 62, 62′ cover the width of loops S.

As illustrated in FIG. 11-4, O-formers 60, 60′ then clamp wire binding element 41 by rotation around preliminary pivot points (not shown) toward booklet 10. Up to this moment, flat, looped wire binding element 41 is in centering funnels 65′ of the second C-former with points 41 s against the stop. As soon as wire binding element 41 is clamped in this position by O-formers 60, 60′, a comb-threading device can be removed or wire binding element 41 can be released in another way, because for the remainder of the method of the present invention, except for the centering of wire binding element 41 with precise position within the device of the present invention, it is always located in precise position by C-formers 50, 50′ or O-formers 60, 60′.

Next, as illustrated in FIG. 11-5, first C-former 50 is moved into centering position in the Y-direction. First C-former 50 is located in a centering position if wedge-shaped centering element 53 on base side 41 k of wire binding element 41 is brought into the areas in between the legs of loops S of wire binding element 41.

The centering, as shown in FIGS. 11-6, is supported by O-formers 60, 60′ briefly releasing the clamping of wire binding element 41 so that a movement or alignment of wire binding element 41 can be achieved until base side 41k of wire binding element 41 comes to rest precisely in the centering element 53 of first C-former 50, which is provided for this purpose. Then, wire binding element 41 is firmly clamped again by O-formers 60, 60′.

Then, C-formers 50, 50′, as shown in FIG. 11-7 are positioned for bending in that both C-formers 50, 50′ movie into the insertion position illustrated in FIG. 8 using first C-former 50.

Consequently, as illustrated in FIG. 11-8, C-formers 50, 50′ are rotated in relation to second C-former 50′ into the clamping position of wire binding element 41, as shown in FIG. 8.

Next, as shown in FIG. 11-9, the bending operation of C-formers 50, 50′ begins by swinging first C-former 50 around fixed pivot point P1 and second C-former 50′ around fixed pivot point P1′ (see FIG. 10). In so doing, wire binding element 41 is over-bent in order to compensate for the elastic spring-back of the wire.

As shown in FIG. 11-10, O-formers 60, 60′ next loosen the clamping of wire binding element 41, which is henceforth present in C-shape 41c, approach bending positions corresponding to pivot points P2, P2′ and there, in turn, clamp the wire binding element 41 (see FIG. 11-11). The position of pivot point P2, P2′ is in turn dependent on loop length L of the wire binding element and is predetermined by a controller (not shown).

Next, C-formers 50, 50′ go back into the position shown in FIG. 11-12, C-formers 50, 50′ running through the same curves as in the bending of wire binding element 41, however, in the opposite direction until wire binding element 41, which is bent into C-shape 41c, is present in the stress-free state. Then, C-formers 50, 50′ rotate around pivot points P1 or P1′, in order to release the clamping via clamp flanks 55, 55′ or tab flanks 56, 56′.

Next, C-formers 50, 50′ move out of wire binding element 41 in C-shape 41c and into a park position above the comb-threading plane, as shown in FIG. 11-13. At the same time, the park position is selected in such a manner that C-formers 50, 50′ lie outside the movement space of O-formers 60, 60′ with O-shapes.

After that, O-formers 60, 60′ bend wire binding element 41, which is present at that moment in C-shape 41c, into a closed O-shape as shown in FIG. 11-14. At the same time, as during the C-forming, the wire binding element 41 is over-bent in order to compensate for the spring-back of the wire, so that wire binding element 41 in the stress-free state is in the desired shape.

Next, O-formers 60, 60′ go back into the position shown in FIG. 11-15, O-formers 60, 60′ passing through the same curves as with the bending of wire binding element 41, but in the opposite direction, until wire binding element 41, which is bent into O-shape 41o, is in the stress-free state. Then, O-formers 60, 60′ rotate around pivot points P2 and P2′, respectively, in order to release the clamping via bending elements 64, 64′.

Next, O-formers 60, 60′ first move in the Z-direction into the intermediate spaces between loops S and then in the Y-direction out of wire binding element 41. Finally, O-formers 60, 60′ rotate into a horizontal position in order to release access to the now bound booklets 10 (see FIGS. 11-16).

Finally, the booklets, as shown in FIG. 11-17, can be driven out from device of the present invention or manually removed.

As is evident from the description of the method and the movement sequences, C-formers 50, 50′ or O-formers 60, 60′ are essentially not a function of loop length L, but only limited by the possibilities for movement on guides provided for this purpose. The adaptation to loop length L of wire binding element 41 is accomplished via the position and movement curves of C-formers 50, 50′ or O-formers 60, 60′. The size of tabs 62, 62′ of O-formers 60, 60′, which together with the spine must have space inside the wire binding element that is enclosed within O-shape 41o, represents a limitation of loop length L below. However, because sheet-form printing materials 11 in booklet 10 also must move in the bound state, this represents practically no technical limitation for the format of a booklet that is to be bound 10.

By bending the flat, looped wire binding element into a continuous C-shape in the manner of a circular arc, an especially aesthetically pleasing look of the wire binding element may be achieved.

In an advantageous configuration of the device according to the invention, varying loop lengths may be bent without having to undertake a retooling of the device.

Advantageously, the C-formers may have clamp flanks and tabs, these tabs being equipped with a tab flank, tab flank and clamp flank cooperating to clamp the looped wire binding element. In this context the clamping of the looped wire binding element in C-formers may be advantageously created solely by the bending movement of the C-formers. As a result, the surface of the wire is protected, among other things. Moreover, no additional moving parts are required that would necessitate a clamping of the wire binding element.

In a preferred embodiment, the C-formers have centering elements for the centering of the flat, looped wire binding element within the booklet. The flat looped wire binding element is manually inserted or inserted automatically using a wire binding device through holes in the sheet-form printing materials. In order to ensure that the C-formers and the O-formers receive the wire binding element for mounting in such a manner that an optimal aesthetic O-shape may be bent together, it is advantageous if the wire binding element is precisely positioned at the beginning of the bending operation. In accordance with one aspect of the present invention, this is achieved via a series of funnels and centering elements that are assigned to the loops of the wire binding element in the C-formers.

In an advantageous embodiment, the C-formers each have drives for a rotary movement and drives for movement in the X-direction and Y-direction as well as a controller for driving the movement of the C-formers. The controller in this context is advantageous in that it controls the drives of the C-formers when bending the flat looped wire binding element into a C-shape in such a manner that the pivot point of the movement of the two C-formers is within the looped wire binding element. In this way it may be achieved that the torque that clamps the wire binding element during bending and thereby holds it in a fixed position remains constant, and no additional forces arise in the longitudinal direction with respect to the looping direction that would lead to the displacement of the loop within the clamp. This prevents the loop from not being deformed and the wire from being scratched.

In an especially advantageous manner, a flat looped wire binding element can be bent into an O-shape if the movements of the two C-formers during the bending operation run synchronously with each other. In this way additional lateral forces are prevented and the wire binding element in the O-shape becomes rounder.

In an advantageous embodiment of the device according to the invention, the O-formers have tabs running perpendicular to the loop direction of the looped wire binding element, the tabs being shorter than the spacing between two loops of the looped wire binding element. The O-formers are advantageously used to ease the threading of the flat wire binding element in the sheet-form printing materials for stabilizing the printing materials and for that reason are arranged beneath the holes. At a later point in time, namely when the wire binding element is to be further bent into a C-shape, the tabs of the O-formers, which are open on one side, allow the O-formers to dip into the plane of the loop of the wire binding element in order then to grip the loop of the wire binding element by lateral movement.

Advantageously, the O-formers may each have drives for a rotary movement, drives for movement in the X-direction and Y-direction and a controller for driving the movement of the O-formers. In this context, the control of the drives of the O-formers during bending of the flat looped wire binding element into an O-shape may be such that the pivot point of the movement of the two O-formers lies within the looped wire binding element.

Advantageously, the movements of the O-formers during the bending operation may also run synchronously with each other.

In addition, the O-formers may each have a drive for the movement of the O-formers in the Z-direction and control means for control of the movement in the Z-direction. In this way, the above-described operation of the tabs of the O-former dipping into the loop plane may be carried out automatically.

Also the clamping of the -looped wire binding element during O-formation may be advantageously produced solely by the bending movement of the O-formers.

In an especially advantageous embodiment of the device of the present invention, a controller determines speed profiles for the movement of the C-formers and O-formers for different loop lengths of the flat, looped wire binding element, so that a wire binding element is bent together into an O-shape with a corresponding diameter. In so doing, the determination of the speed profiles may include a calculation of the speed profiles with respect to predetermined loop lengths or loop lengths determined via sensor technology. On the other hand, the loop length that is relevant for the movement of the C-forms or O-forms could also be transferred from a device and/or controller that is connected in series or at a higher level. Another possibility is that the speed profiles for the movement of the C-formers or O-formers only have to be stored in and read from reference tables. Advantageously, the speed profiles may be converted into control signals for the drives of the C-formers or O-formers. In this way different loop lengths and, thus, booklets having different thicknesses can be bound using the same tool, namely the C-formers or O-formers of the present invention.

Advantageously, the movement of the C-formers or O-formers may be configured in such a manner that the looped wire binding element is over-bent by the C-formers or O-formers so that the wire binding element is released into the desired shape when relaxed. During the wire bending, the elastic range of the wire must first be overcome in order to achieve a permanent deformation of the wire. Even when there is a permanent deformation, the wire springs back to the elastic range accordingly. In order to obtain a desired bending shape, bending must therefore be carried past the desired shape in accordance with the expected spring-back.

In a preferred embodiment of the device according to the invention, the O-formers are configured in such a manner that, at least for each individual loop of the looped wire binding element, individual bending elements are provided that are fastened to the particular O-former in such a manner as to be replaceable. In so doing, the number of the bending elements per O-former is at least as great as the number of loops that are used for the loose binding of the largest format of sheet-form printing materials that are to be processed. Since the O-formers are parts having relatively complex geometry, the manufacturing effort and, thus, the piece costs can be reduced by division into individual, structurally similar bending elements. Should individual bending elements be damaged, e.g. by the tabs breaking off, this also has the advantage that in this case only the individual bending elements must be changed out, thereby substantially reducing the costs for tool replacement. Alternatively, all bending elements may also be mounted on bars, each of the bars carrying a number of individual bending elements, e.g. 4 or 6. In this embodiment, the bending elements may then be attached to the particular O-formers by bars in such a manner as to be replaceable.

According to another aspect of the concept of the present invention, to achieve the objective a method for the loose binding of booklets that are composed of sheet-form printing materials that in turn are provided with holes is disclosed using at least one looped wire binding element and having the steps:

a) Introduction of the originally flat, looped wire binding element through holes of the sheet-form printing materials,

b) Bending of the flat, looped wire binding element into a continuous arched C-shape using two C-formers,

c) Bending of the looped wire binding element that is in a C-shape into a closed O-shape using two O-formers.

Advantageously, the method may be carried out independently of the loop length of the flat, looped wire binding element.

In an especially advantageous embodiment of the method of the present invention, the bending is simultaneously carried out for all wire loops of a wire binding element for a wire comb binding. The parallel bending of all wire loops of a wire binding element for a wire comb binding substantially accelerates the processing of the wire binding element. Moreover, it may be ensured that all arcs along the wire binding element have the same curved line. As a result, in a complete wire comb binding having a bent wire comb there is an aesthetic exterior and an improved functionality, especially when turning the pages of a booklet having a wire comb binding produced in this manner. It is also within the framework of the method of the present invention to use O-formers or C-formers distributed along the wire binding element with which, for example, only half or a third of all wire loops of a wire binding element are simultaneously bent in order to reduce the forces that emerge in this context. Other subdivisions of bending bars are also conceivable.

Although the invention was described in reference to preferred exemplary embodiments, the invention is not restricted to them, but can undergo changes and adaptations within its area of applicability.

What is claimed is:

1. A method for binding sheet-form printing materials with a looped wire binding element, comprising:
bending the looped wired binding element into a C-shape with two C-formers; and
bending the C-shape into a closed shape with two O-formers, the closed shape containing the sheet-form printing materials.

2. The method of claim 1, wherein the wire binding element is initially flat.

3. The method of claim 1, comprising clamping the wire binding element during C-forming solely by pivoting the two C-formers.

4. The method of claim 1, comprising clamping the wire binding element during O-forming solely by pivoting the two O-formers.

5. The method of claim 1, comprising bending different loop lengths without retooling.

6. The method of claim 1, comprising pivoting each C-former about a corresponding pivot point located within the wire binding element.

7. The method of claim 1, comprising pivoting the two C-formers synchronously.

8. The method of claim 1, comprising pivoting each O-former about a corresponding pivot point located within the wire binding element.

9. The method of claim 1, wherein all movements of the two O-formers are synchronous.

10. The method of claim 1, comprising clamping the looped wire binding element during closing solely by pivoting the O-formers.

11. The method of claim 1, comprising over-bending the looped wire binding element such that the looped wire binding element is released into a desired form when relaxed.

12. A device for binding sheet-form printing materials with a wire binding element having at least one loop, comprising two C-formers and two O-formers, the two C-formers being pivotable to bend the at least one loop into a C-shape; and the two O-formers being pivotable to bend the C-shape into a closed shape that contains the sheet-form printing materials.

13. The device of claim 12, the C-formers comprising centering elements that center the wire binding element within the sheet-form printing materials.

14. The device of claim 12, the O-formers comprising tabs that are perpendicular to a direction of the loops, the tabs being shorter than a space between loops.

15. The device of claim 12, the two O-formers each comprising replaceable bending elements fastened to the O-formers.

16. A device for the loose binding of sheet-form printing materials for brochures by means of a looped wire binding element, comprising two C-formers, the C-formers being mounted in such a manner that an initially flat looped wire binding element is bent into a C-shape, and having two O-formers, the O-formers being mounted in such a manner that the looped wire binding element that is bent in a C-shape is bent into a closed shape.

17. The device of claim 16, wherein the O-formers are configured to clamp the wire binding element by pivoting the O-formers.

18. The device of claim 16, wherein each C-former is pivotable about a corresponding pivot point located within the wire binding element.

19. The device of claim 16, the C-formers comprising centering elements that center the wire binding element within the sheet-form printing materials.

20. The device of claim 16, the O-formers comprising tabs that are perpendicular to a direction of the loops, the tabs being shorter than a space between loops.

21. The device of claim 16, the two O-formers each comprising replaceable bending elements fastened to the O-formers.

22. The device of claim 16, the C-formers comprising clamp flanks and tabs, the tabs comprising tab flanks, the tab flanks and clamp flanks cooperating to clamp the looped wire binding element.
